(19) United States
(12) Patent Application Publication
(10) Pub. No.: US 2023/0078571 A1
(43) Pub. Date: Mar. 16, 2023

(54) INFORMATION DISPLAY METHOD, APPARATUS, ELECTRONIC DEVICE, COMPUTER-READABLE STORAGE MEDIUM AND COMPUTER PROGRAM PRODUCT

(71) Applicant: Tencent Technology (Shenzhen) Company Limited, Shenzhen (CN)

(72) Inventor: Lingyun LIN, Shenzhen (CN)

(73) Assignee: Tencent Technology (Shenzhen) Company Limited, Shenzhen (CN)

(21) Appl. No.: 17/992,557

(22) Filed: Nov. 22, 2022

Related U.S. Application Data
(63) Continuation of application No. PCT/CN2021/143032, filed on Dec. 30, 2021.

(30) Foreign Application Priority Data
Feb. 5, 2021 (CN) 202110164947.6

(51) Int. Cl. A63F 13/537; A63F 13/69; A63F 13/533; A63F 13/847

(52) U.S. Cl. CPC A63F 13/537; A63F 13/69; A63F 13/533; A63F 13/847

(57) ABSTRACT

An information display method, apparatus, an electronic device, a computer-readable storage medium and a computer program product. The information display method includes: displaying a game control interface corresponding to a first virtual object, the first virtual object being in a virtual environment in a first health state, and the virtual environment including a second virtual object in a second health state, receiving a check operation for the second virtual object, the check operation being an operation of checking, by the first virtual object using a check skill, state conversion information of the second virtual object, the state conversion information being information associated with a state conversion of the second virtual object from the first health state to the second health state, and displaying the state conversion information in the game control interface based on the check operation.

### CROSS-REFERENCE TO RELATED APPLICATION(S)

This application is a continuation application of International Application No. PCT/CN2021/143032, filed on Dec. 30, 2021, which claims priority to Chinese Patent Application No. 202110164947.6 filed with the China National Intellectual Property Administration on Feb. 5, 2021, the disclosures of which are herein incorporated by reference in their entireties.

### FIELD

The disclosure relates to the technical field of computers, and particularly relates to an information display method, apparatus, an electronic device, a computer-readable storage medium and a computer program product.

### BACKGROUND

In a function application based on a virtual environment, such as a first-person game, it is possible to achieve game playing between virtual objects. Under a condition that a virtual object A defeats a virtual object B, the result information that the virtual object A defeats the virtual object B will be displayed in current game.

Due to the fact that there are multiple types of display information in the game and the frequency of game playing between the virtual objects is high, the result information related to the game is frequently updated and displayed, and a user cannot effectively master the result information related to the game which the user is interested in the complex display information. That is, the result information display pertinence is poor, and therefore the information interaction efficiency in the virtual environment is low.

### SUMMARY

An aspect of an example embodiment provides an information display method, and the method includes: displaying a game control interface corresponding to a first virtual object, the first virtual object being in a virtual environment in a first health state, and the virtual environment further including a second virtual object in a second health state; receiving a check operation for the second virtual object, the check operation being an operation of checking, by the first virtual object using a check skill, state conversion information of the second virtual object, the state conversion information being information associated with a state conversion of the second virtual object from the first health state to the second health state; and displaying the state conversion information in the game control interface based on the check operation.

An aspect of an example embodiment provides an information display apparatus including: at least one memory configured to store program code; and at least one processor configured to read the program code and operate as instructed by the program code, the program code comprising: first displaying module configured to cause the at least one processor to display a game control interface corresponding to a first virtual object, the first virtual object being in a virtual environment in a first health state, and the virtual environment further including a second virtual object in a second health state; receiving module configured to cause the at least one processor to receive a check operation for the second virtual object, the check operation being an operation of checking, by the first virtual object using a check skill, state conversion information of the second virtual object, the state conversion information being information associated with a state conversion of the second virtual object from the first health state to the second health state; and second displaying module configured to cause the at least one processor to display the state conversion information in the game control interface based on the check operation.

An aspect of an example embodiment provides an electronic device for information display, including a processor and a memory. The memory stores at least one instruction, at least one program, and a code set or an instruction set, and the at least one instruction, the at least one program, and the code set or the instruction set is loaded and executed by the processor to implement the information display method provided in an example embodiment.

An aspect of an example embodiment provides a non-transitory computer-readable storage medium. The computer-readable storage medium stores computer code that when executed by at least one processor causes the at least one processor to implement the information display method provided in an example embodiment.

An aspect of an example embodiment provides a computer program product or a computer program. The computer program product or the computer program includes a computer instruction. The computer instruction is stored in a computer-readable storage medium. A processor of a terminal reads the computer instructions from the computer-readable storage medium, and executes the computer instructions, to cause the terminal to implement the information display method provided in an example embodiment.

### BRIEF DESCRIPTION OF THE DRAWINGS

To describe the technical solutions of example embodiments of this disclosure more clearly, the following briefly introduces the accompanying drawings for describing the example embodiments. The accompanying drawings in the following description show only some embodiments of the disclosure, and a person of ordinary skill in the art may still derive other drawings from these accompanying drawings without creative efforts. In addition, one of ordinary skill would understand that aspects of example embodiments may be combined together or implemented alone.

FIG. 1 is a schematic diagram of an implementation environment according to some embodiments.

FIG. 2 is a flow chart of an information display method according to some embodiments.

FIG. 3 is a flow chart of an information display method according to some embodiments.

FIG. 4 is a flow chart of an information display method according to some embodiments.

FIG. 5 is a schematic diagram of a game control interface according to some embodiments.

FIG. 6 is a schematic diagram of a game control interface according to some embodiments.

FIG. 7 is a flow chart of a skill pickup method according to some embodiments.

FIG. 8 is a schematic diagram of collision detection according to some embodiments.

FIG. 9 is a flow chart of an information display method according to some embodiments.

FIG. 10 is a flow chart of an information display method according to some embodiments.

FIG. 11 is a structural block diagram of an information display apparatus according to some embodiments.

FIG. 12 is a structural block diagram of a terminal according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict.

In some embodiments, “a plurality of” means two or more. The “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

First, terms involved in some embodiments are introduced as follows:

1) Virtual environment: a virtual environment displayed (or provided) by an application program when run on a terminal. The virtual environment may be any one of a 2D virtual environment, a 2.5-dimensional virtual environment, and a 3D virtual environment, an example in which the virtual environment is a 3D virtual environment is used for description in some embodiments. In some embodiments, the virtual environment is further used for a game between at least two virtual objects. In some embodiments, there are virtual resources available to the at least two virtual objects in the virtual environment.

2) Virtual object: a movable object in a virtual environment. The movable object may be at least one of a virtual character, a virtual animal, and an animation character. In some embodiments, when the virtual environment is a 3D virtual environment, the virtual object may be a 3D model. Each virtual object has a respective shape and size in the three-dimensional virtual environment, and occupies some space in the three-dimensional virtual environment. In some embodiments, the virtual object is a three-dimensional character constructed based on three-dimensional human skeleton technology. The virtual object wears different virtual skins to implement different appearances. In some embodiments, the virtual objects may be alternatively implemented by using a 2.5-dimensional model or a two-dimensional model. This is not limited herein.

3) Virtual prop: It is a prop that a virtual object can use in a virtual environment, including a virtual weapon that can cause damage to another virtual object, a supply prop, a defensive prop, a virtual prop such as a virtual beam or a virtual shock wave shown through a hand when being used for casting a skill by the virtual object, and a body part of the virtual object, such as a hand or a leg.

4) User interface (UI) control: It is any visual control or element that can be seen in a UI of a function application, such as a picture control, an input box control, a text box control, a button control, or a label control. Some UI controls are configured to receive an operation of a user.

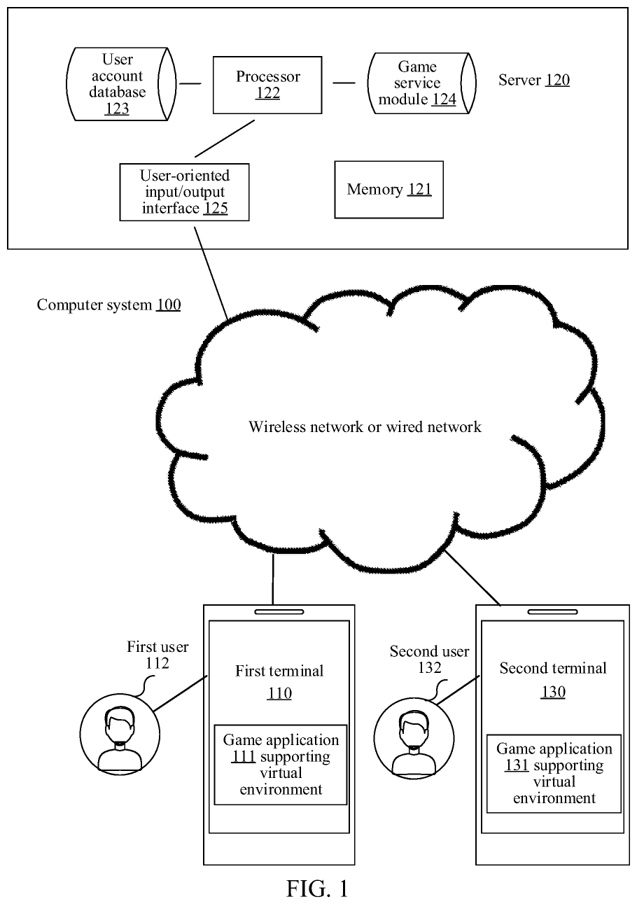

FIG. 1 is a schematic diagram of an implementation environment according to some embodiments. The implementation environment is used for supporting a computer system 100. The computer system 100 may include: a first terminal 110, a server 120, and a second terminal 130.

A game application 111 supporting a virtual environment is installed and run on the first terminal 110, and the game application 111 may be a multiplayer online game program. When the first terminal 110 runs the game application 111, a UI of the game application 111 is displayed on a screen of the first terminal 110. The game application 111 may be any one of a multiplayer online battle arena (MOBA) game, an escape shooting game, and a simulation game (SLG). In some embodiments, an example in which the game application 111 is a MOBA game is used for description. The first terminal 110 is a terminal used by a first user 112. The first user 112 uses the first terminal 110 to control a first virtual object located in the virtual environment to perform activities, and the first virtual object may be referred to as a master virtual object of the first user 112. Activities of the first virtual object include, but are not limited to: at least one of adjusting body postures, crawling, walking, running, riding, flying, jumping, driving, picking, shooting, attacking, throwing, and skill releasing. For example, the first virtual object is a first virtual character such as a simulated character or an animation character.

A game application 131 supporting a virtual environment is installed and run on the second terminal 130, and the game application 131 may be a multiplayer online game program. When the second terminal 130 runs the game application 131, a UI of the game application 131 is displayed on a screen of the second terminal 130. The client may be any one of a MOBA game, an escape shooting game, and an SLG. In this embodiment of this application, an example in which the game application 131 is a MOBA game is used for description. The second terminal 130 is a terminal used by a second user 132. The second user 132 uses the second terminal 130 to control a second virtual object located in the virtual environment to perform activities, and the second virtual object may be referred to as a master virtual object of the second user 132. In some embodiments, the second virtual object is a second virtual character, such as a simulated character or an animation character.

In some embodiments, the first virtual object and the second virtual object are located in the same virtual environment. In some embodiments, the first virtual object and the second virtual object may belong to the same faction, the same team, or the same organization, have a friend relationship with each other, or have a temporary communication permission. In some embodiments, the first virtual object and the second virtual object may belong to different factions, different teams, or different organizations, or have a hostile relationship with each other.

In some embodiments, the game application installed on the first terminal 110 is same as the game application installed on the second terminal 130, or the applications installed on the two terminals are game applications of a same type on different operating system platforms (such as Android or IOS). The first terminal 110 may generally refer to one of a plurality of terminals, and the second terminal 130 may generally refer to another one of a plurality of terminals. In this embodiment of this application, only the first terminal 110 and the second terminal 130 are used as an example for description. The device types of the first terminal 110 and the second terminal 130 are the same or different. The device types include: at least one of a smart phone, a tablet computer, an e-book reader, a Moving Picture Experts Group Audio Layer III (MP3) player, a Moving Picture Experts Group Audio Layer 4 (MP4) player, a laptop portable computer, and a desktop computer.

In some embodiments, there are two factions in the game: a first faction and a second faction. The first virtual object belongs to the first faction or the second faction; when the first virtual object belongs to the first faction, faction information of the virtual object in the second faction is invisible in the game control interface displayed by the first terminal 110, and the first user 112 can control the first virtual object to defeat the virtual object of the second faction and maintain virtual device in the virtual environment to win the game; and when the first virtual object belongs to the second faction, faction information of the virtual object in the first faction is visible in the game control interface displayed by the first terminal 110, and the first user 112 can control the first virtual object in the first faction to defeat the virtual object of the first faction and destroy the virtual device in the virtual environment to win the game. The second virtual object belongs to the first faction or the second faction; when the second virtual object belongs to the first faction, the faction information of the virtual object in the second faction is invisible in the game control interface displayed by the second terminal 130, and the second user 132 can control the second virtual object to defeat the virtual object of the second faction and maintain the virtual device in the virtual environment to win the game; and when the second virtual object belongs to the second faction, the faction information of the virtual object in the first faction is visible in the game control interface displayed by the second terminal 130, and the second user 132 can control the second virtual object to defeat the virtual object of the first faction and destroy the virtual device in the virtual environment to win the game.

FIG. 1 shows two terminals. However, a plurality of other terminals may access the server 120 in different embodiments. In some embodiments, one or more terminals are terminals corresponding to a developer. A developing and editing platform for the game application supporting a virtual environment is installed on the terminal. The developer may edit and update the game application on the terminal and transmit an updated game application installation package to the server 120 by using a wired or wireless network. The first terminal 110 and the second terminal 130 may download the game application installation package from the server 120 to update the game application. The first terminal 110, the second terminal 130, and the other terminals are connected to the server 120 through a wireless or wired network.

The server 120 includes at least one of one server, a server cluster including a plurality of servers, a cloud computing platform, and a virtualization center. The server 120 is configured to provide a backend service for a game application program supporting a three-dimensional virtual environment. In some embodiments, the server 120 bears more computation work than the terminal; or the server 120 bears the computation work less than or equal to the terminal; or cooperative computation is carried out between the server 120 and the terminal by a distributed computation architecture.

In some embodiments, the server 120 includes a memory 121, a processor 122, a user account database 123, a game service module 124, and a user-oriented input/output (I/O) interface 125. The processor 122 is capable of loading an instruction stored in the server 120 and processing data in the user account database 123 and the game service module 124; the user account database 123 is used for storing data of user accounts used by the first terminal 110, the second terminal 130 and other terminals, such as head portraits of the user accounts, nicknames of the user accounts, fighting capacity indexes of the user accounts, and service areas with the user accounts; the game service module 124 is capable of providing a plurality of game rooms for users to play games, such as a 1V (Versus) 1 game, a 3V3 game, a 5V5 game, and an MVN game (M and N are not equal positive integers); and a user-oriented I/O interface 125 is used for establishing communication exchange data with the first terminal 110 and/or the second terminal 130 through a wireless network or a wired network.

In order to implement a game in the virtual environment, after the game starts, health state conversion information corresponding to the fact that a virtual object in the virtual environment is defeated by other virtual objects will be publicized in a global virtual environment, consequently, the user easily misses the health state conversion information which the user is interested in the frequently updated and publicized health state conversion information. In some embodiments, an electronic device (such as the terminal) for information display will display the state conversion information only under the condition that the user actively checks the second virtual object in a dead state through the carried check skill, thus the displayed state conversion information can be ensured to be the information meeting the acquisition requirement of the user, and the user can effectively master the interested state conversion information; and therefore, the pertinence of information display can be improved, and the efficiency of information interaction in the virtual environment is improved.

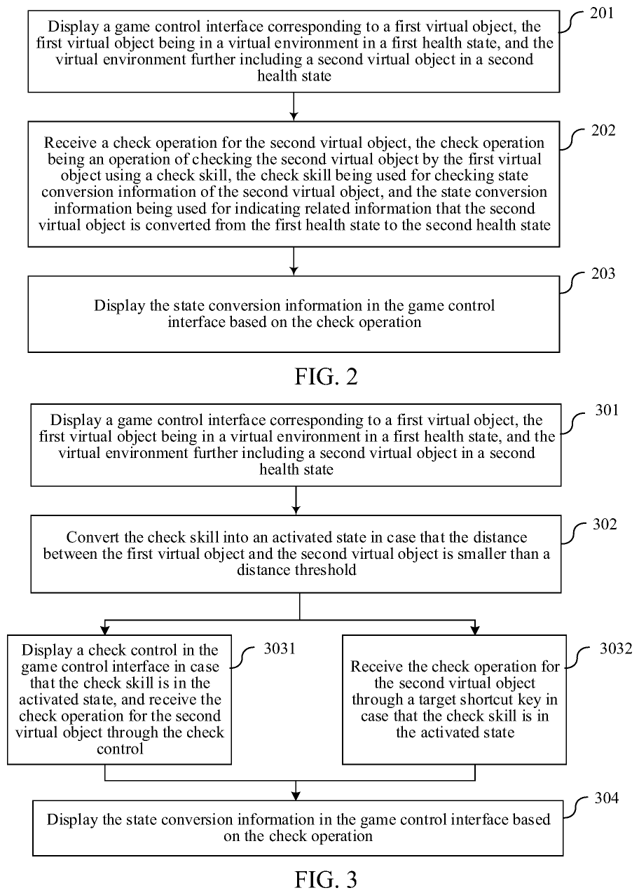

FIG. 2 is the flow chart of the information display method according to the embodiment of this application. This embodiment of this application is described by using an example in which the information display method is executed by a first terminal 110 or a second terminal 130 in an implementation environment shown in FIG. 1 or another terminal in the implementation environment. The information display method includes operation 201 to operation 203:

Operation 201. Display a game control interface corresponding to a first virtual object, the first virtual object being in a virtual environment in a first health state, and the virtual environment further including a second virtual object in a second health state.

In some embodiments, after the game starts, the terminal is capable of displaying the game control interface corresponding to the first virtual object, the first virtual object being in the virtual environment, and the first virtual object being in the first health state.

In some embodiments, the first health state refers to a survival state, such as a state that the health point is not lower than a specified value. In the survival state, the first virtual object is supported to perform activities in the virtual environment, and the activities of the first virtual object include but are not limited to: at least one of adjusting body postures, crawling, walking, running, riding, flying, jumping, driving, picking, shooting, attacking, throwing, and skill releasing.

In some embodiments, a single-round game includes two factions: a first faction and a second faction, and the user needs to control the first virtual object to battle the virtual object in an enemy faction so as to acquire the victory of the faction of the first virtual object. The faction information of the virtual object in the first faction is visible to the virtual object in the second faction, and the faction information of the virtual object in the second faction is invisible to the virtual object in the first faction. The first virtual object belongs to the first faction, and the first virtual object is in the first health state in the virtual environment.

In some embodiments, the virtual objects in the game are divided into defenders (namely the virtual objects in the first faction) and lurks (namely the virtual objects in the second faction); the first virtual object belongs to the defenders, faction information of the first virtual object is displayed as defenders in the game control interface of the first virtual object, and faction information of other virtual objects in the virtual environment is invisible to the first virtual object.

The virtual environment further includes a second virtual object in the second health state, and faction information of the second virtual object is invisible to the first virtual object.

Operation 202. Receive a check operation for the second virtual object, the check operation being an operation of checking the second virtual object by the first virtual object using a check skill, the check skill being used for checking state conversion information of the second virtual object, and the state conversion information being used for indicating related information that the second virtual object is converted from the first health state to the second health state.

In some embodiments, the terminal is capable of checking the state conversion information of the second virtual object by receiving the check operation of the user for the second virtual object so as to obtain the state conversion information matched with the check skill.

In some embodiments, the terminal is capable of receiving the check operation, corresponding to the check skill, triggered by the first virtual object for the second virtual object only under the condition that the first virtual object carries the check skill. The state conversion information is used for indicating related information that the second virtual object is converted from the first health state to the second health state.

In some embodiments, the second health state refers to a dead state, such as a state that the health point is equal to a specified value. In the dead state, the second virtual object is not supported to perform activities in the virtual environment. In some embodiments, the second virtual object in the dead state is not supported to perform reincarnation.

In some embodiments, the first virtual object is not an attack virtual object which converts the second virtual object from the first health state to the second health state. That is, the first virtual object cannot check the second virtual object under the condition that the first virtual object is the attack virtual object which causes the conversion of the health state of the second virtual object.

In some embodiments, the check operation includes: triggering operation on the check control, or input operation on the target shortcut key. The embodiment of this application does not limit the implementation of the check operation. Exemplary, when the second virtual object is in the second health state, the check control will be displayed at the corresponding position (such as the position of the second virtual object) of the second virtual object so as to promote other virtual objects that the second virtual object can be checked; when the distance between the first virtual object and the second virtual object is smaller than a distance threshold, namely, the distance between the first virtual object and the second virtual object meets the distance requirement, the user triggers the displayed checking control, so that the terminal can receive the check operation of checking the state conversion information of the second virtual object.

In some embodiments, the user inputs a shortcut key corresponding to the check skill, and then the terminal receives the check operation of checking the state conversion information of the second virtual object.

In some embodiments, for the second virtual object in the second health state, other virtual objects (such as the first virtual object) can only perform specified times (such as once) of check operations on the second virtual object, thus the terminal can receive the specified times of check operations.

In some embodiments, after the first virtual object checks the second virtual object, other virtual objects cannot check the second virtual object again, that is, after the terminal receives the check operation of the first virtual object for the second virtual object, the check operation for the second virtual object cannot be received again.

In some embodiments, the mode of the first virtual object carrying the check skill includes at least one of the following modes: a mode of automatically configuring the check skill at the beginning of the game; a mode of meeting an unlocking condition in the game playing process so as to unlock the check skill; and a mode of acquiring the check skill through the pickup operation, and exchanging the check skill through virtual resources.

In some embodiments, the unlocking condition includes at least one of the follows: the duration of the game reaches a target duration; and the achievement of the first virtual object reaches a target achievement. For example, if the duration of the game reaches 4 min, a first check skill is unlocked, and thus the first virtual object carries a first check skill; and if the duration of the game reaches 5 min, a second check skill is unlocked, and thus the first virtual object carries a second check skill. For another example, if the integral of the first virtual object reaches a first target integral, a third check skill is unlocked, and thus the first virtual object carries a third check skill; and if the integral of the first virtual object reaches a second target integral, a fourth check skill is unlocked, and thus the first virtual object carries a fourth check skill.

In some embodiments, the check skill carried by the first virtual object corresponds to a quantity threshold. In some embodiments, the quantity threshold is 3, and the first virtual object can only carry less than 3 check skills. In some embodiments, the level of the quantity threshold can be modified by the first virtual object using a modification prop, for example, the quantity threshold is expanded from 3 to 5 by the modification prop.

Operation 203. Display state conversion information in the game control interface based on the check operation.

In some embodiments, after the duration of receiving the check operation reaches a preset duration, the terminal is capable of displaying the state conversion information in the game control interface to complete the response to the check operation. For example, after the check operation is received for 2 s, the terminal will display the state conversion information.

In some embodiments, the state conversion information is used for indicating related information that the second virtual object is converted from the survival state to the dead state.

In some embodiments, the terminal is capable of determining whether to carry out global publicizing on the state conversion information of the second virtual object or not; and if the terminal receives a global publicizing operation triggered by the user, the terminal responds to the operation to carry out global publicizing, i.e., the terminal corresponding to each virtual object in the game displays the state conversion information, so that all virtual objects in the game can acquire the state conversion information.

It is to be understood that when the second virtual object in the dead state is in the virtual environment, the terminal is capable of checking the second virtual object under the condition that the check operation is received, and displaying the state conversion information so as to display related information that the second virtual object is converted from the survival state to the dead state. The display of the state conversion information depends on the check skill carried by the first virtual object in checking the second virtual object; the terminal will display the state conversion information only when the user actively checks the second virtual object through the carried check skill, thus the displayed state conversion information can be ensured to be the information meeting the acquisition requirement of the user, the user can effectively master the interested state conversion information, and the pertinence of result information display can be improved.

It is further to be understood that there are two factions in the game: the first faction and the second faction, and under the condition that the faction information of the virtual object in the first faction is visible to the virtual object in the second faction and the faction information of the virtual object in the second faction is invisible to the virtual object in the first faction, if the first virtual object belongs to the first faction, the second virtual object can be checked through the check skill, and thus the user corresponding to the first virtual object is able to speculate the virtual object in the second faction based on state conversion information obtained through check.

In some embodiments, the check skill carried by the first virtual object needs to meet the activation condition so as to be activated, and then the first virtual object triggers the check operation through the activated check skill; and therefore, the use of the check operation in a fixed scene can be limited, and as a result, the simulation of the checking process is ensured.

FIG. 3 is the flow chart of the information display method according to the embodiment of this application. This embodiment of this application is described by using an example in which the information display method is executed by a first terminal 110 or a second terminal 130 in an implementation environment shown in FIG. 1 or another terminal in the implementation environment. The information display method includes the following operations:

Operation 301. Display a game control interface corresponding to a first virtual object, the first virtual object being in a virtual environment in a first health state, and the virtual environment further including a second virtual object in a second health state.

The implementation of this operation refers to operation 201.

Operation 302. Convert the check skill into an activated state when the distance between the first virtual object and the second virtual object is smaller than a distance threshold.

In some embodiments, if the virtual environment includes the second virtual object in the second health state, the terminal is capable of detecting the distance between the first virtual object and the second virtual object; and under the condition that the distance between the first virtual object and the second virtual object meets the distance requirement, for example, the distance between the first virtual object and the second virtual object is smaller than the distance threshold, the check skill carried by the first virtual object is converted into the activated state. In some embodiments, the number of the activated check skills is at least one.

In some embodiments, the check skill in the activated state is identified in a highlight mode; or the check skill in the activated state is identified in a flickering mode; or the check skill in the activated state is identified in an amplifying mode. The embodiment of this application does not limit the expression form of the check skill in the activated state on the interface.

Operation 3031. Display a check control in the game control interface when the check skill is in the activated state, and receive the check operation for the second virtual object through the check control.

In some embodiments, in case of determining that the check skill carried by the first virtual object is in the activated state, the terminal will display the check control in a battle control interface; and if the user triggers the check control, the terminal will correspondingly receive the check operation.

Operation 3032. Receive the check operation for the second virtual object through a target shortcut key when the check skill is in the activated state.

In some embodiments, under the condition that the terminal receives the input operation, which corresponds to the target shortcut key, of the user, the terminal will regard the input operation which corresponds to the target shortcut key as the check operation for the second virtual object, and correspondingly control the first virtual object to check the second virtual object with the check skill.

It is to be understood that the input operation which corresponds to the target shortcut key can be realized through an entity keyboard, a handle, a virtual keyboard carried by the terminal and the like. The embodiment of this application does not limit it.

Operation 304. Display state conversion information in the game control interface based on the check operation.

The implementation of this operation refers to operation 203.

It is to be understood that according to the information display method provided in the embodiment of this application, if the second virtual object in the second health state is in the virtual environment, the terminal is capable of detecting the distance between the first virtual object and the second virtual object, and under the condition that the distance between the first virtual object and the second virtual object meets the distance requirement, the check skill will be activated, and then the first virtual object will trigger the check operation through the activated check skill; and due to the fact that the check operation needs to be triggered under the condition that the distance between the first virtual object and the second virtual object meets the distance requirement, thus the simulation of the check process of the first virtual object on the second virtual object is guaranteed, and the rendering effect of the virtual environment is improved.

In some embodiments, the check skill includes at least one of the image check skill, the prop check skill and the searching skill; and since the state conversion information is matched with the check skill, correspondingly, the state conversion information includes at least one of virtual object information, virtual prop information and searching guidance information.

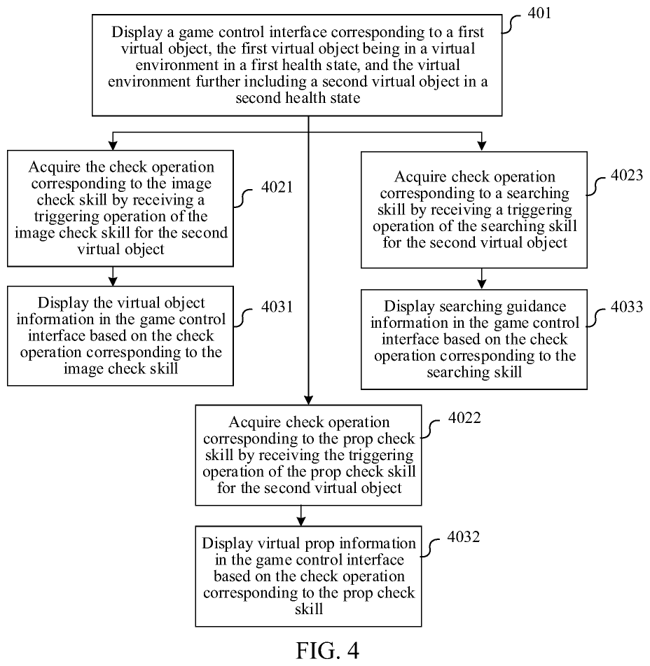

FIG. 4 is the flow chart of the information display method according to the embodiment of this application. This embodiment of this application is described by using an example in which the information display method is executed by a first terminal 110 or a second terminal 130 in an implementation environment shown in FIG. 1 or another terminal in the implementation environment. The information display method includes the following operations:

Operation 401. Display a game control interface corresponding to a first virtual object, the first virtual object being in a virtual environment in a first health state, and the virtual environment further including a second virtual object in a second health state.

The implementation of this operation refers to operation 201.

Operation 4021. Acquire the check operation corresponding to the image check skill by receiving a triggering operation of the image check skill for the second virtual object.

In some embodiments, when the check skill includes the image check skill, and the second virtual object in the second health state is in the virtual environment, and under the condition that the image check skill is in the activated state, the terminal is capable of receiving the triggering operation of the image check skill for the second virtual object, and thus the check operation is obtained. The image check skill is a skill used for checking other virtual objects observed before the virtual object entering the second health state; and it is to be understood that all skills with the above functional attributes can be regarded as the image check skills in the embodiment of this application. In some embodiments, the image check skill can also be called an image reconstruction skill.

In some embodiments, the image check skill belongs to a passive skill, and can be used for a long time after being carried by the first virtual object, and its use frequency is not limited.

Operation 4031. Display the virtual object information in the game control interface based on the check operation corresponding to the image check skill.

In some embodiments, when the check skill includes the image check skill, the state conversion information includes virtual object information, and the virtual object information is used for indicating a virtual object observed by the second virtual object before the second virtual object is in the second health state; and the terminal is capable of displaying the virtual object information in the game control interface based on the triggering operation for the image check skill.

In some embodiments, the number of virtual objects indicated in virtual object information is one. Before the second virtual object is in the second health state, namely before the second virtual object is subjected to state conversion process, the second virtual object possibly observes a plurality of other virtual objects, and the virtual object information is used for indicating the last observed virtual object in the plurality of other virtual objects observed by the second virtual object.

In some embodiments, an attack virtual object which converts the second virtual object from the first health state to the second health state includes a third virtual object; and the terminal is capable of displaying virtual object information in the game control interface based on the triggering operation for the image check skill through the following possible implementations.

One mode includes: displaying the virtual object information in the game control interface based on the triggering operation for the image check skill when the third virtual object does not trigger a hiding skill in the state conversion process of the second virtual object, the virtual object information including object identifier information of the third virtual object, and the hiding skill and the image check skill being in a mutual exclusion relationship.

In some embodiments, the terminal is capable of acquiring a skill triggering condition of the third virtual object in the state conversion process of the second virtual object by the terminal, and displaying the virtual object information in the game control interface based on the triggering operation for the image check skill under the condition that it is determined that the third virtual object does not trigger the hiding skill based on the obtained skill triggering condition, the virtual object information being the object identification information of the third virtual object. The object identifier information of the third virtual object is used for indicating the third virtual object. The object identifier information of the third virtual object includes at least one of the follows: a nickname of the third virtual object and a number of the third virtual object in the game.

The hiding skill of the third virtual object refers to a skill for controlling the third virtual object to be in a hidden state, and the third virtual object in the hidden state cannot be observed by other virtual objects. In some embodiments, the hiding skill corresponds to an effective duration, such as 15 s. In some embodiments, if other virtual objects are close to the third virtual object (for example, the distance between the other virtual objects is smaller than a specified distance) in the hidden state, the contour of the third virtual object can be observed.

It is to be understood that the mutual exclusion relationship between the hiding skill and the image check skill refers to that the use result (namely the displayed virtual object information) of the image check skill is influenced by the hiding skill. Under the condition that the third virtual object triggers the hiding skill in the state conversion process of the second virtual object, the first virtual object cannot effectively use the image check skill to acquire accurate virtual object information of the second virtual object, so that the hiding skill and the image check skill are in the mutual exclusion relationship.

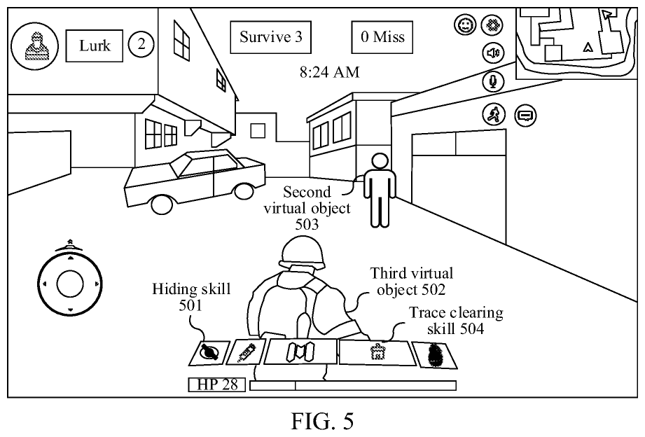

FIG. 5 shows one game control interface corresponding to the third virtual object, and the faction of the third virtual object is a lurk faction. A hiding skill 501 is displayed in the game control interface, and the hiding skill 501 is triggered to be in the activated state; and a third virtual object 502 is in the hidden state, and the third virtual object 502 cannot be observed by a second virtual object 503 even if the third virtual object is right opposite to the second virtual object 503. The third virtual object 502 attacks the second virtual object 503 and defeats the second virtual object 503, and thus the second virtual object 503 is converted from the first health state to the second health state.

Another mode includes: displaying the virtual object information in the game control interface based on the check operation for the image check skill when the third virtual object triggers the hiding skill in the state conversion process of the second virtual object, the virtual object information including object identifier information of the fourth virtual object; or displaying failure information in the game control interface based on the check operation for the image check skill when the third virtual object triggers the hiding skill in the state conversion process of the second virtual object, and the failure information being used for indicating that the hiding skill is triggered.

The fourth virtual object is a virtual object observed by the second virtual object before the second virtual object is in the second health state. It is to be understood that the third virtual object cannot be observed relative to the second virtual object due to the fact that the third virtual object triggers the hiding skill in the state conversion process of the second virtual object.

In some embodiments, due to the mutual exclusion relationship between the hiding skill and the image check skill, under the condition that the third virtual object triggers the hiding skill in the state conversion process of the second virtual object, the virtual object observed by the second virtual object before the second virtual object is in the second health state does not include the third virtual object; the virtual object information displayed by the terminal includes the object identifier information of the fourth virtual object; and the fourth virtual object is the virtual object observed by the second virtual object before the second virtual object is in the second health state. The object identifier information of the fourth virtual object is used for indicating the fourth virtual object. The object identifier information of the fourth virtual object includes at least one of the follows: the nickname of the fourth virtual object and the number of the fourth virtual object in the game.

In some embodiments, after the last virtual object observed by the second virtual object in the first health state is the fourth virtual object, the second virtual object is attacked by the third virtual object with the hiding skill triggered to perform the state conversion process, and the virtual object information includes object identifier information of the fourth virtual object.

In some embodiments, due to the mutual exclusion relationship between the hiding skill and the image check skill, under the condition that the third virtual object triggers the hiding skill in the state conversion process of the second virtual object, the virtual object observed by the second virtual object before the second virtual object is in the second health state does not include the third virtual object; and if the first virtual object cannot check an accurate virtual object which enables second virtual object to perform the state conversion process through the image check skill, the terminal will display failure information, and the failure information is used for indicating that the hiding skill is triggered.

Operation 4022. Acquire check operation corresponding to the prop check skill by receiving the triggering operation of the prop check skill for the second virtual object.

In some embodiments, when the check skill includes the prop check skill, the second virtual object in the second health state is in the virtual environment, and under the condition that the prop check skill is in the activated state, the terminal is capable of receiving the triggering operation of the prop check skill for the second virtual object so as to obtain the check operation. The prop check skill is used for checking the virtual prop which enables virtual object to be in the second health state; and it is to be understood that all skills with the above functional attributes can be regarded as prop check skills in the embodiment of this application. In some embodiments, the prop check skill can also be called an eagle eye skill.

In some embodiments, the prop check skill belongs to a passive skill, and can be used for a long time after being carried by the first virtual object, and its use frequency is not limited.

Operation 4032. Display virtual prop information in the game control interface based on the check operation corresponding to the prop check skill.

In some embodiments, when the check skill includes prop check skill, the state conversion information includes virtual prop information, and the virtual prop information is used for indicating the virtual prop which enables the second virtual object to perform the state conversion process, and the terminal will display the virtual prop information in the game control interface on the basis of the triggering operation for the prop check skill.

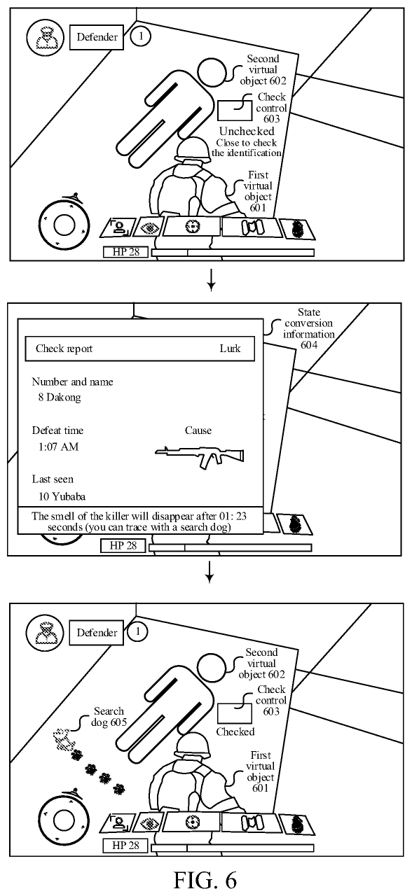

FIG. 6 shows another game control interface corresponding to the first virtual object, and the faction of the first virtual object is a defender faction. After a second virtual object 602 is defeated, a check control 603 is displayed nearby, prompt information (which is not checked, close to check the identification) is also displayed, and the check control 603 supports simultaneous triggering of the image check skill and the prop check skill. The user triggers the check control 603 to enable the terminal to control a first virtual object 601 to check the second virtual object 602, and after check is completed, the terminal displays state conversion information 604, and the state conversion information 604 includes virtual object information “last seen: 10 Yubaba” and virtual prop information.

Operation 4023. Acquire check operation corresponding to a searching skill by receiving a triggering operation of the searching skill for the second virtual object.

In some embodiments, when the check skill includes the searching skill, and the second virtual object in the second health state is in the virtual environment, and under the condition that the searching skill is in the activated state, the terminal is capable of receiving the triggering operation of the searching skill for the second virtual object so as to obtain the check operation. The searching skill is a skill used for searching other virtual objects which enable the virtual object to be in the second health state; and it is to be understood that all skills with the above function attributes can be regarded as the searching skills in the embodiment of this application. In some embodiments, the searching skill can also be called a search dog skill.

In some embodiments, the searching skill belongs to an active skill, and the corresponding use frequency of the searching skill is limited after being carried by the first virtual object, for example, the searching skill can only be used once.

Operation 4033. Display searching guidance information in the game control interface based on the check operation corresponding to the searching skill.

In some embodiments, when the check skill includes the searching skill, the state conversion information includes searching guidance information, the searching guidance information is used for indicating a path from the first virtual object to the third virtual object in the virtual environment, and the third virtual object is the attack virtual object for converting the second virtual object from the first health state to the second health state; and the terminal is capable of displaying the searching guidance information in the game control interface based on the triggering operation for the searching skill.

In some embodiments, the terminal is capable of displaying the searching guidance information in the game control interface based on the triggering operation for the searching skill in the following possible implementations.

One mode includes: displaying the searching guidance information in the game control interface through the terminal based on the triggering operation for the searching skill when the third virtual object does not trigger a trace clearing skill for the second virtual object in the second health state, and the searching skill and the trace clearing skill being in a mutual exclusion relationship.

In some embodiments, the terminal is capable of acquiring the skill triggering condition of the third virtual object for the second virtual object when the second virtual object is in the second health state, and displaying searching guidance information in the game control interface based on the triggering operation for the searching skill under the condition that the third virtual object does not trigger the trace clearing skill for the second virtual object based on the obtained skill triggering condition.

The trace clearing skill of the third virtual object refers to a skill for controlling to clear personal trace characteristics related to the third virtual object staying on the second virtual object. In some embodiments, the personal trace characteristics include smell characteristics.

In some embodiments, continuing to refer to FIG. 5, FIG. 5 shows the game control interface corresponding to the third virtual object, and the faction of the third virtual object is lurk faction. A trace clearing skill 504 is displayed in the game control interface, and after the second virtual object 503 is defeated by the third virtual object 502, the third virtual object 502 can use the trace clearing skill 504 for the second virtual object 503 in the second health state.

It is to be understood that the mutual exclusion relationship between the searching skill and the trace clearing skill refers to that the use result of the searching skill is influenced by the trace clearing skill. Under the condition that the third virtual object triggers the trace clearing skill for the second virtual object in the second health state, there are no personal trace characteristics related to the third virtual object on the second virtual object any more, the first virtual object cannot search the third virtual object by the searching skill according to the personal trace characteristics related to the third virtual object, and therefore the searching skill and the trace clearing skill are in the mutual exclusion relationship.

Another mode includes: determining that the duration limit is not broken when the state conversion duration of the second virtual object is shorter than a specified duration, and displaying the searching guidance information in the game control interface through the terminal based on the check operation for the searching skill, the state conversion duration referring to the duration of the second virtual object in the second health state after the second virtual object converts from the first health state to the second health state.

In some embodiments, the personal trace feature related to the third virtual object staying on the second virtual object is effective within the duration limit; the terminal is capable of acquiring the state conversion duration of the second virtual object, searching the third virtual object by the searching skill based on the triggering operation for the searching skill and according to the personal trace characteristics related to the third virtual object under the condition that the state conversion duration does not exceed the duration limit, and displaying the searching guidance information in the game control interface.

In some embodiments, continuing to refer to FIG. 6, FIG. 6 shows the game control interface corresponding to the first virtual object, and the faction of the first virtual object is a defender factor. The second virtual object 602 is defeated by the third virtual object, and the third virtual object does not use the trace clearing skill on the second virtual object 602. After the second virtual object 602 is defeated, the terminal is capable of starting to time the state conversion duration of the second virtual object 602, and displaying that prompt information “the smell of the killer will disappear after 01:23 seconds (you can trace with a search dog)” is used by the searching skill based on the state conversion duration. After the user inputs the shortcut key corresponding to the searching skill, the first virtual object 601 is controlled to use the searching skill, a search dog 605 will be generated in the virtual environment, and the motion track of the search dog 605 in the virtual environment can be regarded as the path from the first virtual object 601 to the third virtual object; and the user can control the first virtual object 601 to search the third virtual object according to the guidance of the search dog, and thus the terminal will display related information of the first virtual object 601 searching the third virtual object according to the guidance of the search dog.

It is to be understood that in the information display method provided in the embodiment of this application, the terminal is capable of controlling the first virtual object to check the second virtual object through carried check skills such as the image check skill, the prop check skill and the searching skill, and representing the checked state conversion information for the user to acquire the state conversion information. The state conversion information includes the last virtual object observed by the second virtual object, a virtual prop through which the second virtual object is defeated, and a trace of the third virtual object which defeats the second virtual object, thus the first virtual object can selectively acquire the state conversion information in different aspects based on the types of carried check skills, and as a result, the flexibility of man-machine interaction is improved.

It is to be understood that in the game, the first virtual object can carry other types of skills besides the above check skills. The other types of skills will be simply introduced as follows.

1) Dead silence skill: it is for hiding the footstep sound of the first virtual object.

In some embodiments, the server controls the terminal participating in the game to adjust the action volume of the first virtual object to be 0, so that the mute effect is achieved.

2) Virtual body armor: it is used for reducing damage to the first virtual object.

In some embodiments, the virtual body armor will automatically take effect after being held by the first virtual object, and the terminal will present a body armor icon when determining that the first virtual object is attacked so that an attacker can see the body armor icon; and the terminal will control the body armor to automatically lose efficacy after determining that the number of defense points of the body armor reaches the damage of a point threshold.

3) Virtual Molotov: it is used for enabling fire and combustion in the virtual environment.

In some embodiments, the fire caused by the virtual Molotov can damage the virtual objects in the virtual environment.

4) Unmanned Aerial Vehicle (UAV): it is used for scanning the current positions of all the virtual objects once and displaying the current positions on a small map.

5) Virtual lifeinjector: it is used for moving acceleration and health point recovery of the first virtual object.

In some embodiments, the virtual lifeinjector is supported to be released in the moving process.

In some embodiments, the terminal is capable of controlling the check skill to be obtained through pickup in the virtual environment so as to control the first virtual object to carry the check skill to check the second virtual object.

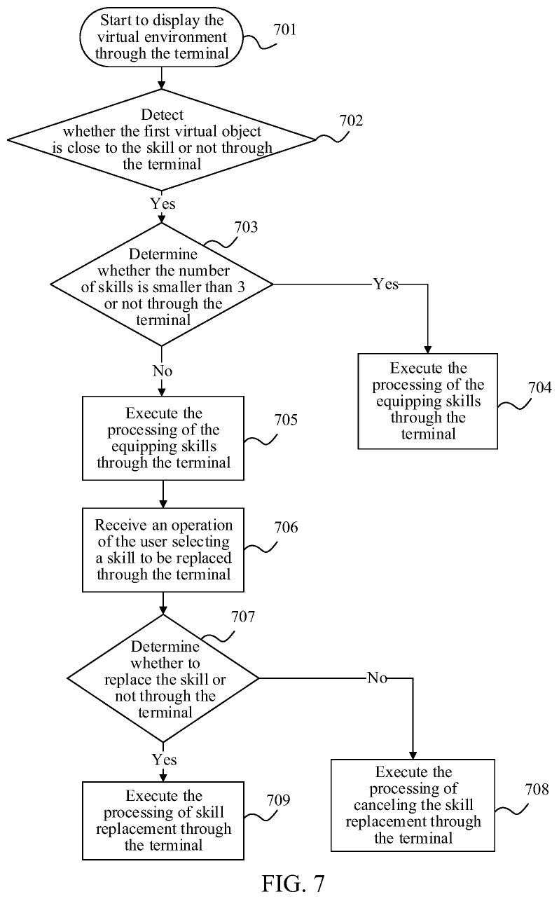

FIG. 7 is the flow chart of the skill pickup method according to the embodiment of this application, and the skill pickup method includes the following operations.

Operation 701. Start to display the virtual environment through the terminal.

Operation 702. Detect whether the first virtual object is close to the skill or not through the terminal.

In some embodiments, the detection is realized through a collision box. Each skill to be picked up corresponds to a collision box, and the terminal detects whether the first virtual object is close to the skill or not by detecting whether the collision box corresponding to the first virtual object and the collision box corresponding to the skill have intersection in space or not.

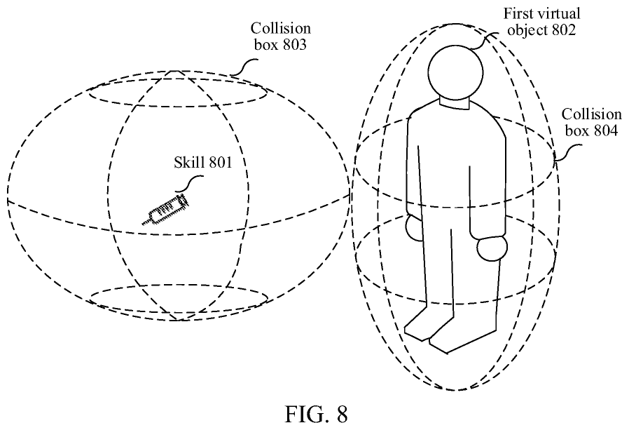

As shown in FIG. 8, a skill 801 and a first virtual object 802 in the virtual environment are each provided with a collision box, and if a collision box 804 of the first virtual object 802 makes contact with a collision box 803 of the skill 801, it is determined that the first virtual object 802 is close to the skill 801.

In some embodiments, the terminal is capable of displaying the skills to be picked up as a unified icon; and the terminal responds to the operation that the user controls the first virtual object to be close to pick up and displays the specific name of the skill and the corresponding independent icon in the virtual environment.

In some embodiments, after the game starts, the server will randomly display one skill in the designated range corresponding to each virtual object in the terminal virtual environment, and then the terminal will present 1-2 skills by an air drop falling skill.

Operation 703. Determine whether the number of skills is smaller than 3 or not through the terminal.

In some embodiments, the number of skills supported to be carried by the first virtual object is at most 3. The skills include check skills and other types of skills. If the number of the skills is smaller than 3, operation 704 is performed; and if the number of the skills is greater than or equal to 3, operation 705 is performed.

Operation 704. Execute the processing of the equipping skills through the terminal;

Due to the fact that the number of the skills carried by the first virtual object is smaller than 3, the first virtual object can directly equip the picked up skills.

Operation 705. Pop up a skill box through the terminal.

The skill box includes skills carried by the first virtual object.

Operation 706. Receive an operation of the user selecting a skill to be replaced through the terminal.

In some embodiments, the user selects the skill to be replaced in the skill box, and the terminal receives the operation of the user selecting the skill to be replaced.

Operation 707. Determine whether to replace the skill or not through the terminal.

In some embodiments, after the user selects the skill to be replaced, the terminal will display replacement confirmation information and prompts the user to confirm whether to replace the skill or not. When the user cancels the skill replacement, the terminal will respond to the cancellation operation of the user to determine not to replace the skill, and operation 708 is executed; and when the user determines to replace the skill, the terminal responds to the confirmation operation of the user to determine that the skill is replaced, and operation 709 is executed.

Operation 708. Execute the processing of canceling the skill replacement through the

terminal.

Operation 709. Execute the processing of skill replacement through the terminal.

It is to be understood that in the information display method provided in the embodiment of this application, the check skill can be obtained in the virtual environment in a pickup mode, and it can be guaranteed that the first virtual object can carry the check skill to check the second virtual object so as to present state conversion information, and as a result, the user can acquire more tactical reference information.

In some embodiments, if the first virtual object carries the prop check skill or the image check skill and is close to a certain second virtual object (namely a virtual object in the dead state) in the second health state, a UI will be popped up to prompt the user whether to check the second virtual object or not.

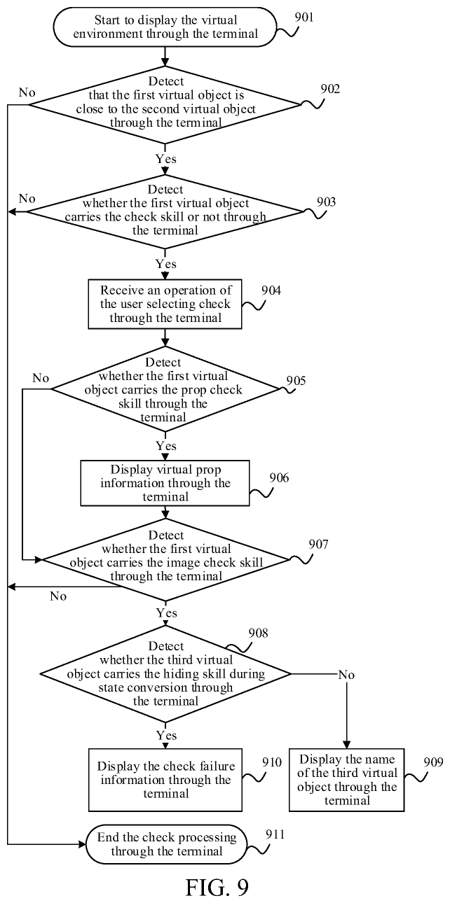

FIG. 9 shows the flow chart of the information display method according to the embodiment of this application. The information display method includes the following operations.

Operation 901. Start to display the virtual environment through the terminal.

Operation 902. Detect whether the first virtual object is close to the second virtual object or not through the terminal.

In some embodiments, the detection is realized through a collision box. Each virtual object in the virtual environment corresponds to a collision box, and the terminal detects whether the first virtual object is close to the second virtual object or not by detecting whether the collision box corresponding to the first virtual object and the collision box corresponding to the second virtual object have an intersection in space or not. If the terminal detects that the first virtual object is close to the second virtual object, operation 903 is executed, otherwise, operation 911 is executed.

Operation 903. Detect whether the first virtual object carries the check skill or not through the terminal.

In some embodiments, the prop check skill and the image check skill are both passive skills and are supported to be used by the first virtual object for multiple times. When the terminal detects that the first virtual object carries at least one of the prop check skill and the image check skill, operation 904 is executed. Otherwise, operation 911 is executed.

Operation 904. Receive an operation of the user selecting check through the terminal.

In some embodiments, if the user executes the operation of selecting check, the operation of the user selecting check received by the terminal is the check operation for the second virtual object.

Operation 905. Detect whether the first virtual object carries the prop check skill through the terminal.

When the terminal determines that the first virtual object carries the prop check skill, operation 906 is executed. Otherwise, operation 907 is executed.

Operation 906. Display virtual prop information through the terminal.

The virtual prop information is used for indicating a virtual prop which enables the second virtual object to be subjected to state conversion.

Operation 907. Detect whether the first virtual object carries the image check skill through the terminal.

When the terminal determines that the first virtual object carries the image check skill, operation 908 is executed, otherwise, operation 911 is executed.

Operation 908. Detect whether the third virtual object carries the hiding skill during state conversion through the terminal.

The third virtual object is the attack virtual object which converts the second virtual object from the first health state to the second health state. The hiding skill is a skill having a mutual exclusion relationship with the image check skill.

In some embodiments, the terminal is capable of acquiring information whether the third virtual object carries the hiding skill or not when attacking the second virtual object from the server side so as to detect whether the third virtual object carries the hiding skill or not when the second object is subjected to state conversion. When the terminal determines that the third virtual object does not carry the hiding skill during state conversion, operation 909 is executed; and when the third virtual object carries the hiding skill, operation 910 is executed.

Operation 909. Display the name of the third virtual object through the terminal.

Operation 910. Display the check failure information through the terminal.

Operation 911. End the check processing through the terminal.

It is to be understood that in the information display method provided in the embodiment, the prop check skill carried by the first virtual object can be used for detecting the virtual prop through which the second virtual object is defeated, and the image check skill carried by the first virtual object can be used for detecting the virtual object observed before the second virtual object is defeated; and meanwhile, the terminal takes the detected information as the state conversion information, and displays the state conversion information for the user to acquire more tactical reference information.

In some embodiments, when the first virtual object carries the searching skill and is close to a certain second virtual object in the second health state, the UI will be popped up to prompt the user whether to search the second virtual object or not.

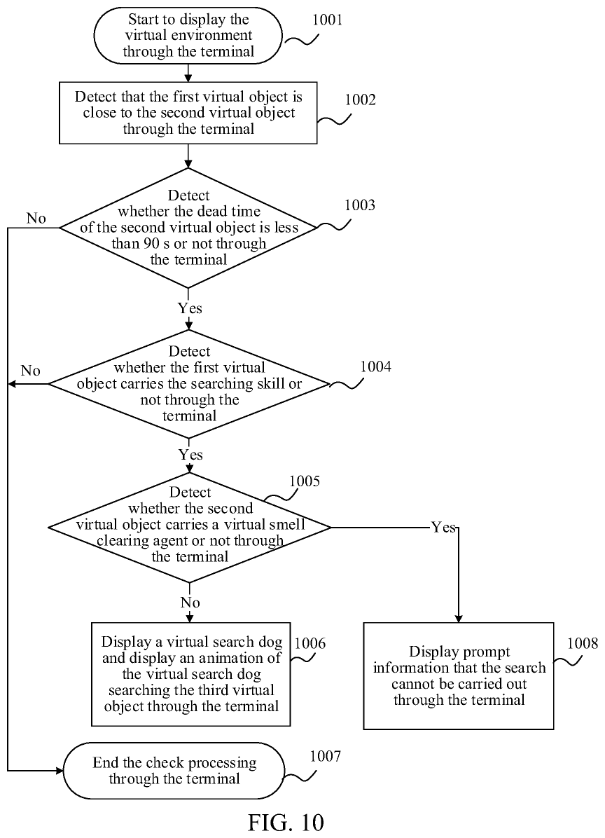

FIG. 10 shows the flow chart of the information display method according to the embodiment of this application. The information display method includes the following operations.

Operation 1001. Start to display the virtual environment through the terminal.

Operation 1002. Detect that the first virtual object is close to the second virtual object through the terminal.

In some embodiments, the detection is realized through a collision box. Each virtual object in the virtual environment corresponds to a collision box, and the terminal detects whether the first virtual object is close to the second virtual object or not by detecting whether the collision box corresponding to the first virtual object and the collision box corresponding to the second virtual object have an intersection in space or not. If the terminal detects that the collision box corresponding to the first virtual object and the collision box corresponding to the second virtual object have an intersection in space, it is determined that the first virtual object is detected to be close to the second virtual object.

Operation 1003. Detect whether the dead time (named state conversion duration) of the second virtual object is less than 90 s or not through the terminal.

In some embodiments, the smell of the third virtual object remaining on the dead second virtual object can be detected within 90 s. The third virtual object is the attack virtual object which converts the second virtual object from the first health state to the second health state. Under the condition that the dead time is less than 90 s, operation 1004 is executed, otherwise, operation 1007 is executed.

Operation 1004. Detect whether the first virtual object carries the searching skill or not through the terminal.

In some embodiments, the searching skill is an active skill and is only supported to be used once by the first virtual object. When the terminal detects that the first virtual object carries the searching skill, operation 1005 is executed.

Operation 1005. Detect whether the second virtual object carries a virtual smell clearing agent (named trace clearing skill) or not through the terminal.

The virtual smell clearing agent is used for clearing smell of the third virtual object remaining on the dead second virtual object. The virtual smell clearing agent is a skill having a mutual exclusion relationship with the searching skill. When the second virtual object does not have the virtual smell clearing agent, operation 1006 is executed, otherwise, operation 1008 is executed.

Operation 1006. Display a virtual search dog and display an animation of the virtual search dog searching the third virtual object through the terminal.

Operation 1007. End the check processing through the terminal.

Operation 1008. Display prompt information that the search cannot be carried out through the terminal.

It is to be understood that in the information display method provided in the embodiment of this application, the searching skill carried by the first virtual object can search for the third virtual object which defeats the second virtual object; and meanwhile, the terminal takes searching related information as state conversion information, and displays the state conversion information for the user to acquire more tactical reference information.

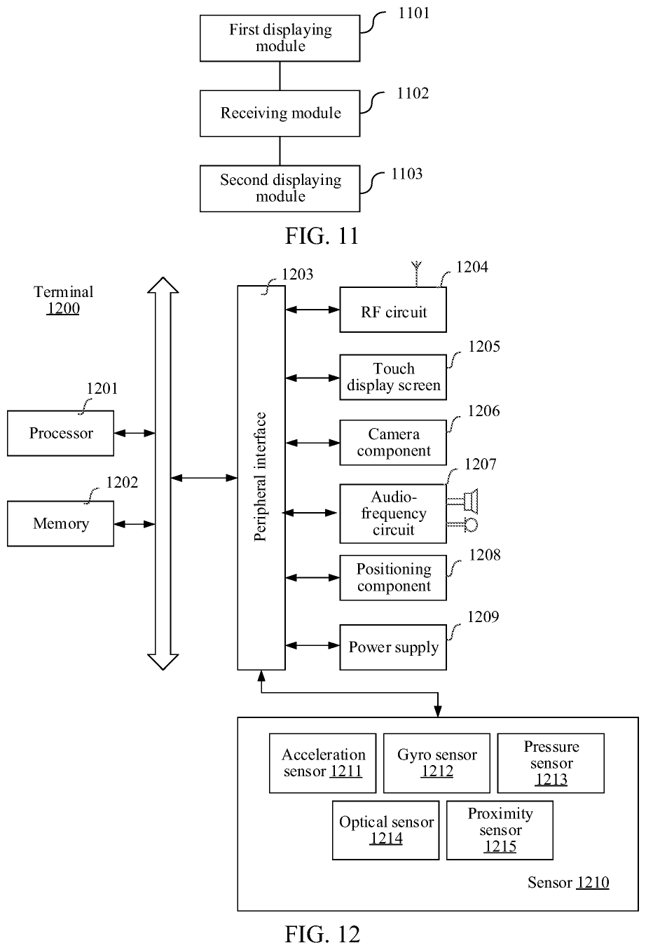

FIG. 11 is the structural block diagram of the information display apparatus according to the embodiment of this application, and the information display apparatus can be treated all or a part of the terminal through software, hardware or combination of the software and the hardware. The information display apparatus includes a first displaying module 1101, a receiving module 1102 and a second displaying module 1103;

the first displaying module 1101 is configured to perform the function of displaying the game control interface corresponding to the first virtual object, the first virtual object being in the virtual environment in the first health state, and the virtual environment further including the second virtual object in the second health state;

the receiving module 1102 is configured to perform the function of receiving the check operation for the second virtual object, the check operation being the operation of checking the second virtual object by the first virtual object using the check skill, the check skill being used for checking state conversion information of the second virtual object, and the state conversion information being used for indicating related information that the second virtual object is converted from the first health state to the second health state; and

the second displaying module 1103 is configured to perform the function of displaying the state conversion information in the game control interface based on the check operation.

In some embodiments, the receiving module 1102 is also configured to perform the functions of converting the check skill into the activated state when the distance between the first virtual object and the second virtual object is smaller than the distance threshold; displaying a check control in the game control interface when that the check skill is in the activated state, and receiving the check operation for the second virtual object through the check control; or, receiving the check operation for the second virtual object through a target shortcut key when that the check skill is in the activated state.

In some embodiments, the check skill includes the image check skill; the state conversion information includes virtual object information, and the virtual object information is used for indicating the virtual object observed by the second virtual object before the second virtual object is in the second health state; and the second displaying module 1103 is further configured to perform the function of displaying the virtual object information in the game control interface based on the check operation corresponding to the image check skill.

In some embodiments, the attack virtual object for converting the second virtual object from the first health state to the second health state includes the third virtual object; the second displaying module 1103 is further configured to perform the function of displaying the virtual object information in the game control interface based on the check operation for the image check skill when the third virtual object does not trigger the hiding skill in the state conversion process of the second virtual object, the virtual object information including object identifier information of the third virtual object, and the hiding skill and the image check skill being in the mutual exclusion relationship; and displaying the virtual object information in the game control interface based on the check operation for the image check skill when the third virtual object triggers the hiding skill in the state conversion process, the virtual object information including object identifier information of the fourth virtual object, and the fourth virtual object being the observed virtual object.

In some embodiments, the second displaying module 1103 is further configured to perform the function of displaying failure information in the game control interface based on the check operation for the image check skill when the third virtual object triggers the hiding skill in the state conversion process, and the failure information being used for indicating that the hiding skill of the third virtual object is triggered.

In some embodiments, the check skill includes the prop check skill; the state conversion information includes virtual prop information, and the virtual prop information is used for indicating the virtual props which enable the second virtual object to be subjected to state conversion; and the second displaying module 1103 is further configured to display the virtual prop information in the game control interface based on the check operation for the prop check skill.

In some embodiments, the check skill includes the searching skill; the state conversion information includes searching guidance information, the searching guidance information is used for indicating the path from the first virtual object to the third virtual object in the virtual environment, and the third virtual object is the attack virtual object for converting the second virtual object from the first health state to the second health state; and the second displaying module 1103 is configured to perform the function of displaying the searching guidance information in the game control interface based on the check operation for the searching skill.

In some embodiments, the second displaying module 1103 is further configured to perform the function of displaying the searching guidance information in the game control interface based on the check operation for the searching skill when the third virtual object does not trigger the trace clearing skill for the second virtual object in the second health state, and the searching skill and the trace clearing skill being in a mutual exclusion relationship.

In some embodiments, the second displaying module 1103 is further configured to perform the function of displaying the searching guidance information in the game control interface based on the check operation for the searching skill when the state conversion duration of the second virtual object is shorter than the specified duration, the state conversion duration referring to the duration of the second virtual object in the second health state.

Referring to FIG. 12, FIG. 12 is the structural block diagram of the terminal 1200 according to the embodiment of this application. The terminal 1200 may be a portable mobile terminal, such as smartphone, a tablet computer, an MP3 player, or an MP4 player. The terminal 1200 may also be referred to as other names such as user equipment and a portable terminal.

Generally, the terminal 1200 includes: a processor 1201 and a memory 1202.

The processor 1201 may include one or more processing cores, such as a 4-core processor or an 8-core processor. The processor 1201 may be implemented by using at least one hardware form of a digital signal processor (DSP), a field-programmable gate array (FPGA), and a programmable logic array (PLA). The processor 1201 may alternatively include a main processor and a coprocessor. The main processor is a processor configured to process data in an active state, also referred to as a central processing unit (CPU). The coprocessor is a low power consumption processor configured to process data in a standby state. In some embodiments, the processor 1201 may be integrated with a graphics processing unit (GPU). The GPU is configured to render and draw content that needs to be displayed on a display screen. In some embodiments, the processor 1201 may further include an artificial intelligence (AI) processor. The AI processor is configured to process a computing operation related to machine learning.

The memory 1202 may include one or more computer-readable storage media. The computer-readable storage medium may be tangible and non-transient. The memory 1202 may also include a high-speed random access memory, as well as non-volatile memory, such as one or more disk storage devices and flash storage devices. In some embodiments, the non-transitory computer-readable storage medium in the memory 1202 is configured to store at least one instruction, and the at least one instruction being configured to be executed by the processor 1201 to implement the information display method provided in some embodiments.

In some embodiments, the terminal 1200 may optionally include a peripheral interface 1203 and at least one peripheral. The peripheral includes at least one of a radio frequency circuit 1204, a touch display screen 1205, a camera assembly 1206, an audio circuit 1207, a positioning assembly 1208, and a power supply 1209.

In some embodiments, the terminal 1200 further includes one or more sensors 1210. The one or more sensors 1210 include but are not limited to an acceleration sensor 1211, a gyro sensor 1212, a pressure sensor 1213, an optical sensor 1214, and a proximity sensor 1215.

It will be appreciated by those skilled in the art that the structure shown in FIG. 12 is not limiting of the terminal 1200 and may include more or fewer assemblies than illustrated, or some assemblies may be combined, or different assembly arrangements may be employed.

Some embodiments further provide a computer-readable storage medium, storing at least one instruction, the at least one instruction being loaded and executed by a processor to implement the information display method in some embodiments.

Some embodiments provide a computer program product or a computer program. The computer program product or the computer program includes a computer instruction. The computer instruction is stored in a computer-readable storage medium. A processor of a terminal reads the computer instructions from the computer-readable storage medium, and executes the computer instructions, to cause the terminal to perform the information display method provided in some embodiments.

A person skilled in the art is to be aware that functions described in some embodiments may be implemented by hardware, software, firmware, or any combination thereof When implemented by using software, the functions can be stored in a computer-readable storage medium or can be used as one or more instructions or code in a computer-readable storage medium for transmission. The computer-readable storage medium includes a computer storage medium and a communication medium, where the communication medium includes any medium that enables a computer program to be transmitted from one place to another. The computer-readable storage medium may be any available medium accessible to a general-purpose or dedicated computer.

The foregoing descriptions are merely optional embodiments of the disclosure, but are not intended to limit the disclosure. Any modification, equivalent replacement, or improvement made within the spirit and principle of the disclosure shall fall within the protection scope of the disclosure.

What is claimed is:

1. An information display method, performed by an electronic device, comprising:
displaying a game control interface corresponding to a first virtual object, the first virtual object being in a virtual environment in a first health state, and the virtual environment further comprising a second virtual object in a second health state;
receiving a check operation for the second virtual object, the check operation being an operation of checking, by the first virtual object using a check skill, state conversion information of the second virtual object, the state conversion information being information associated with a state conversion of the second virtual object from the first health state to the second health state; and
displaying the state conversion information in the game control interface based on the check operation.

2. The information display method according to claim 1, wherein the receiving comprises:
converting the check skill into an activated state based on a distance between the first virtual object and the second virtual object being smaller than a distance threshold;
displaying a check control in the game control interface based on the check skill being in the activated state, and receiving the check operation for the second virtual object through the check control;
or, receiving the check operation for the second virtual object through a target shortcut key based on the check skill being in the activated state.

3. The information display method according to claim 1, wherein the check skill comprises an image check skill;
the state conversion information comprises virtual object information indicating a virtual object observed by the second virtual object before the second virtual object is in the second health state; and
the displaying the state conversion information comprises:
displaying the virtual object information in the game control interface based on the check operation corresponding to the image check skill.

4. The information display method according to claim 3, wherein the second virtual object is converted, by an attack virtual object that is a third virtual object, from the first health state to the second health state;
the displaying the virtual object information comprises:
displaying the virtual object information in the game control interface based on the check operation for the image check skill based on the third virtual object skipping triggering a hiding skill in the state conversion of the second virtual object, the virtual object information comprising object identifier information of the third virtual object, and the hiding skill and the image check skill being in a mutual exclusion relationship; and
displaying the virtual object information in the game control interface based on the check operation for the image check skill based on the third virtual object triggering the hiding skill in the state conversion, the virtual object information comprising object identifier information of a fourth virtual object, and the fourth virtual object being the observed virtual object.

5. The information display method according to claim 4, further comprising:
displaying failure information in the game control interface based on the check operation for the image check skill based on the third virtual object triggering the hiding skill in the state conversion, and the failure information indicating that the hiding skill of the third virtual object is triggered.

6. The information display method according to claim 1, wherein the check skill comprises a prop check skill;
the state conversion information comprises virtual prop information indicating virtual props which enable the second virtual object to be subjected to state conversion; and
the displaying the state conversion information comprises:
displaying the virtual prop information in the game control interface based on the check operation for the prop check skill.

7. The information display method according to claim 4, wherein the check skill comprises a searching skill;
the state conversion information comprises searching guidance information indicating a path from the first virtual object to the third virtual object in the virtual environment, and the third virtual object is the attack virtual object for converting the second virtual object from the first health state to the second health state; and
the displaying the state conversion information comprises:
displaying the searching guidance information in the game control interface based on the check operation for the searching skill.

8. The information display method according to claim 7, wherein the displaying the searching guidance information comprises:
displaying the searching guidance information in the game control interface based on the check operation for the searching skill based on the third virtual object skipping triggering a trace clearing skill for the second virtual object in the second health state, and the searching skill and the trace clearing skill being in a mutual exclusion relationship.

9. The information display method according to claim 7, wherein the displaying the searching guidance information comprises:
displaying the searching guidance information in the game control interface based on the check operation for the searching skill based on a duration of the state conversion of the second virtual object being shorter than a specified duration, the duration of the state conversion being a duration of the second virtual object in the second health state.

10. An information display apparatus, comprising:
at least one memory configured to store program code; and
at least one processor configured to read the program code and operate as instructed by the program code, the program code comprising:
first displaying code configured to cause the at least one processor to display a game control interface corresponding to a first virtual object, the first virtual object being in a virtual environment in a first health state, and the virtual environment further comprising a second virtual object in a second health state;
receiving code configured to cause the at least one processor to receive a check operation for the second virtual object, the check operation being an operation of checking, by the first virtual object using a check skill, state conversion information of the second virtual object, the state conversion information being information associated with a state conversion of the second virtual object from the first health state to the second health state; and
second displaying code configured to cause the at least one processor to display the state conversion information in the game control interface based on the check operation.

11. The information display apparatus according to claim 10, wherein the receiving code is further configured to cause the at least one processor to:
convert the check skill into an activated state based on a distance between the first virtual object and the second virtual object being smaller than a distance threshold;
display a check control in the game control interface based on the check skill being in the activated state, and receiving the check operation for the second virtual object through the check control;
or, receive the check operation for the second virtual object through a target shortcut key based on the check skill being in the activated state.

12. The information display apparatus according to claim 10, wherein the check skill comprises an image check skill;
the state conversion information comprises virtual object information indicating a virtual object observed by the second virtual object before the second virtual object is in the second health state; and
the second displaying code is further configured to cause the at least one processor to display the virtual object information in the game control interface based on the check operation corresponding to the image check skill.

13. The information display apparatus according to claim 12, wherein the second virtual object is converted, by an attack virtual object that is a third virtual object, from the first health state to the second health state;
the second displaying code is further configured to cause the at least one processor to:
display the virtual object information in the game control interface based on the check operation for the image check skill based on the third virtual object skipping triggering a hiding skill in the state conversion of the second virtual object, the virtual object information comprising object identifier information of the third virtual object, and the hiding skill and the image check skill being in a mutual exclusion relationship; and
display the virtual object information in the game control interface based on the check operation for the image check skill based on the third virtual object triggering the hiding skill in the state conversion, the virtual object information comprising object identifier information of a fourth virtual object, and the fourth virtual object being the observed virtual object.

14. The information display apparatus according to claim 13, wherein the second displaying code is further configured to cause the at least one processor to:
display failure information in the game control interface based on the check operation for the image check skill based on the third virtual object triggering the hiding skill in the state conversion, and the failure information indicating that the hiding skill of the third virtual object is triggered.

15. The information display apparatus according to claim 10, wherein the check skill comprises a prop check skill;
the state conversion information comprises virtual prop information indicating virtual props which enable the second virtual object to be subjected to state conversion; and
the second displaying code is further configured to cause the at least one processor to display the virtual prop information in the game control interface based on the check operation for the prop check skill.

16. The information display apparatus according to claim 13, wherein the check skill comprises a searching skill;
the state conversion information comprises searching guidance information indicating a path from the first virtual object to the third virtual object in the virtual environment, and the third virtual object is the attack virtual object for converting the second virtual object from the first health state to the second health state; and
the second displaying code is further configured to cause the at least one processor to display the searching guidance information in the game control interface based on the check operation for the searching skill.

17. The information display apparatus according to claim 16, wherein the second displaying code is further configured to cause the at least one processor to:
display the searching guidance information in the game control interface based on the check operation for the searching skill based on the third virtual object skipping triggering a trace clearing skill for the second virtual object in the second health state, and the searching skill and the trace clearing skill being in a mutual exclusion relationship.

18. The information display apparatus according to claim 16, wherein the second displaying code is further configured to cause the at least one processor to:
display the searching guidance information in the game control interface based on the check operation for the searching skill based on a duration of the state conversion of the second virtual object being shorter than a specified duration, the duration of the state conversion being a duration of the second virtual object in the second health state.

19. A non-transitory computer-readable storage medium, storing computer code that when executed by at least one processor causes the at least one processor to:
display a game control interface corresponding to a first virtual object, the first virtual object being in a virtual environment in a first health state, and the virtual environment further comprising a second virtual object in a second health state;
receive a check operation for the second virtual object, the check operation being an operation of checking, by the first virtual object using a check skill, checking state conversion information of the second virtual object, the state conversion information being information associated with a state conversion of the second virtual object from the first health state to the second health state; and
display the state conversion information in the game control interface based on the check operation.

20. The non-transitory computer-readable storage medium according to claim 19, wherein the program code further causes the at least one processor to receive the check operation for the second virtual object by:
converting the check skill into an activated state based on a distance between the first virtual object and the second virtual object being smaller than a distance threshold;
displaying a check control in the game control interface based the check skill being in the activated state, and receiving the check operation for the second virtual object through the check control;
or, receiving the check operation for the second virtual object through a target shortcut key based on the check skill being in the activated state.
